(19) United States
(12) Patent Application Publication
(10) Pub. No.: US 2014/0153022 A1
(43) Pub. Date: Jun. 5, 2014

(54) ELECTRONIC APPARATUS CAPABLE OF CONTROLLING ORDER IN WHICH JOBS ARE EXECUTED, CONTROL METHOD THEREFOR, AND STORAGE MEDIUM

(71) Applicant: CANON KABUSHIKI KAISHA, Tokyo (JP)

(72) Inventor: Hiroshi YAMAMIZU, Yokohama-shi (JP)

(73) Assignee: CANON KABUSHIKI KAISHA, Tokyo (JP)

(21) Appl. No.: 14/096,312

(22) Filed: Dec. 4, 2013

(30) Foreign Application Priority Data
Dec. 5, 2012 (JP) 2012-266223

(51) Int. Cl. G06K 15/00; G06F 3/12

(52) U.S. Cl. CPC G06K 15/4055; G06F 3/126
USPC 358/1.13

(57) ABSTRACT

An electronic apparatus which is capable of executing jobs in an order in which the jobs were received while maximum power consumption is never exceeded. Based on a list stored in a storage unit, whether or not a job planned to be executed by the electronic apparatus is next on a waiting list is determined. Completion notification indicating that the job has been completed is received from one of at least one external apparatus. Power consumption is obtained from all of the at least one external apparatus when the job is next on a waiting list, and the completion notification is received. The job is executed when a sum of total power consumption of the at least one external apparatus and power consumed when the electronic apparatus executes the job is smaller than maximum power consumption determined in advance.

### BACKGROUND OF THE INVENTION

1. Field of the Invention

The present invention relates to an electronic apparatus, a control method therefor, and a computer-readable storage medium storing a program for implementing the control method.

2. Description of the Related Art

At present, there is a market demand for low-power-consumption electronic apparatuses due to a rise in awareness of environment and energy. Further, more attention needs to be paid to total maximum power consumption of a plurality of electronic apparatuses so that they can prepare for unexpected situations such as shortage in power supply and they can operate within an allowable amount of power supply in a predetermined range of premise to which power is supplied.

An image forming apparatus consumes a relatively large amount of power when it performs printing and consumes a relatively small amount of power when it stands by. There has been a technique according to which an image forming apparatus inquires of another electronic apparatus about power usage conditions, and when, as a result of the inquiry, power consumption exceeds maximum power consumption in a case where the own electronic apparatus performs printing, the own electronic apparatus restrains its printing operation (see, for example, Japanese Laid-Open Patent Publication (Kokai) No. 2006-35441).

With this technical background, an environment in which there are a plurality of image forming apparatuses and a plurality of PCs on a network is considered. In this case, the plurality of PCs is connected to the plurality of image forming apparatuses on the network, and hence no one knows when a job is input from which PC.

In this state, when a job is input to an image forming apparatus other than an image forming apparatus currently executing a job, maximum power consumption may be exceeded. Thus, the job input to the image forming apparatus cannot be executed, and the image forming apparatus is brought into a state of waiting to be executed and waits until total power consumption within the network decreases.

Also, when there are image forming apparatuses whose jobs are waiting to be executed, an additional job may be input to an image forming apparatus currently executing a job.

When an additional job is thus input to an image forming apparatus currently executing a job, the image forming apparatus currently executing the job has a job execution right, and hence the job added to the image forming apparatus having the job execution right may be executed prior to jobs of the other image forming apparatuses that have been waiting to be executed.

A job input to another image forming apparatus waiting to execute a job other than an image forming apparatus having a job execution right may not be executed until the job is completed by the image forming apparatus having the job execution right.

Thus, from the standpoint of users, there is the problem that jobs cannot be executed in the order in which the jobs are input, and the order in which jobs are executed is reversed.

### SUMMARY OF THE INVENTION

The present invention provides an electronic apparatus and a control method therefor, which are capable of executing processes in the order in which the processes were received while maximum power consumption is never exceeded, as well as a computer-readable storage medium storing a program for implementing the control method.

Accordingly, a first aspect of the present invention provides an electronic apparatus which is capable of communicating with at least one external apparatus, and for which maximum power consumption by all of the at least one external apparatus and the electronic apparatus is determined in advance, comprising a storage unit configured to store a list indicating jobs planned to be executed by respective ones of the at least one external apparatus and the electronic apparatus, and indicating that an order in which the jobs planned to be executed are executed is an order in which the at least one external apparatus and the electronic apparatus have received the jobs, an order determination unit configured to, based on the list stored in the storage unit, determine whether the job planned to be executed by the electronic apparatus is next on a waiting list, a receiving unit configured to receive, from any one of the at least one external apparatus, a completion notification indicating that the job executed by the external apparatus has been completed, an obtaining unit configured to obtain power consumption from all of the at least one external apparatus when the order determination unit determines that the job planned to be executed by the electronic apparatus is next on a waiting list, and the receiving unit receives the completion notification, and an execution unit configured to execute the job planned to be executed when a sum of total power consumption of the at least one external apparatus obtained by the obtaining unit and power consumed when the electronic apparatus executes the job planned to be executed is smaller than the maximum power consumption.

Accordingly, a second aspect of the present invention provides a control method for an electronic apparatus which is capable of communicating with at least one external apparatus, and for which maximum power consumable by all of the at least one external apparatus and the electronic apparatus is determined in advance, and has a storage unit that stores a list indicating jobs planned to be executed by respective ones of the at least one external apparatus and the electronic apparatus, and indicating that an order in which the jobs planned to be executed are executed is an order in which the at least one external apparatus and the electronic apparatus have received the jobs, comprising an order determination step of, based on the list stored in the storage unit, determining whether the job planned to be executed by the electronic apparatus is next on a waiting list, a receiving step of receiving, from any one of the at least one external apparatus, a completion notification indicating that the job executed by the external apparatus has been completed, an obtaining step of obtaining power consumption from all of the at least one external apparatus when it is determined in the order determination step that the job planned to be executed by the electronic apparatus is next on a waiting list, and the completion notification is received in the receiving step, and an execution step of executing the job planned to be executed when a sum of total power consumption of the at least one external apparatus obtained in the obtaining step and power consumed when the electronic apparatus executes the job planned to be executed is smaller than the maximum power consumption.

Accordingly, a third aspect of the present invention provides a non-transitory computer-readable storage medium storing a program for causing a computer to execute a control method for an electronic apparatus which is capable of communicating with at least one external apparatus, and for which maximum power consumable by all of the at least one external apparatus and the electronic apparatus is determined in advance, and has a storage unit that stores a list indicating jobs planned to be executed by respective ones of the at least one external apparatus and the electronic apparatus, and indicating that an order in which the jobs planned to be executed are executed is an order in which the at least one external apparatus and the electronic apparatus have received the jobs, the control method comprising an order determination step of, based on the list stored in the storage unit, determining whether the job planned to be executed by the electronic apparatus is next on a waiting list, a receiving step of receiving, from any one of the at least one external apparatus, a completion notification indicating that the job executed by the external apparatus has been completed, an obtaining step of obtaining power consumption from all of the at least one external apparatus when it is determined in the order determination step that the job planned to be executed by the electronic apparatus is next on a waiting list, and the completion notification is received in the receiving step, and an execution step of executing the job planned to be executed when a sum of total power consumption of the at least one external apparatus obtained in the obtaining step and power consumed when the electronic apparatus executes the job planned to be executed is smaller than the maximum power consumption.

According to the present invention, processes can be executed in the order in which the processes were received while maximum power consumption is never exceeded.

Further features of the present invention will become apparent from the following description of exemplary embodiments (with reference to the attached drawings).

### BRIEF DESCRIPTION OF THE DRAWINGS

FIG. 1 is a diagram schematically showing an image forming system including an image forming apparatus according to an embodiment of the present invention.

FIG. 2 is a view showing an appearance of the image forming apparatus appearing in FIG. 1.

FIG. 3 is a diagram schematically showing an arrangement of a controller of the image forming apparatus appearing in FIG. 1.

FIGS. 4A to 4D are diagrams of exemplary job lists stored in RAM appearing in FIG. 3.

FIG. 5 is a flowchart showing the procedure of a job list updating process carried out by a CPU appearing in FIG. 3.

FIGS. 6A and 6B are diagrams showing message formats exchanged between image forming apparatuses.

FIG. 7 is a flowchart showing the procedure of a job power control process carried out by the CPU appearing in FIG. 3.

FIGS. 8A to 8D are diagrams useful in explaining concrete examples in which the job power control process in FIG. 7 is carried out.

### DESCRIPTION OF THE EMBODIMENTS

The present invention will now be described in detail with reference to the drawings showing an embodiment thereof. It should be noted that in the present embodiment, an electronic apparatus according to the present invention is applied to an image forming apparatus.

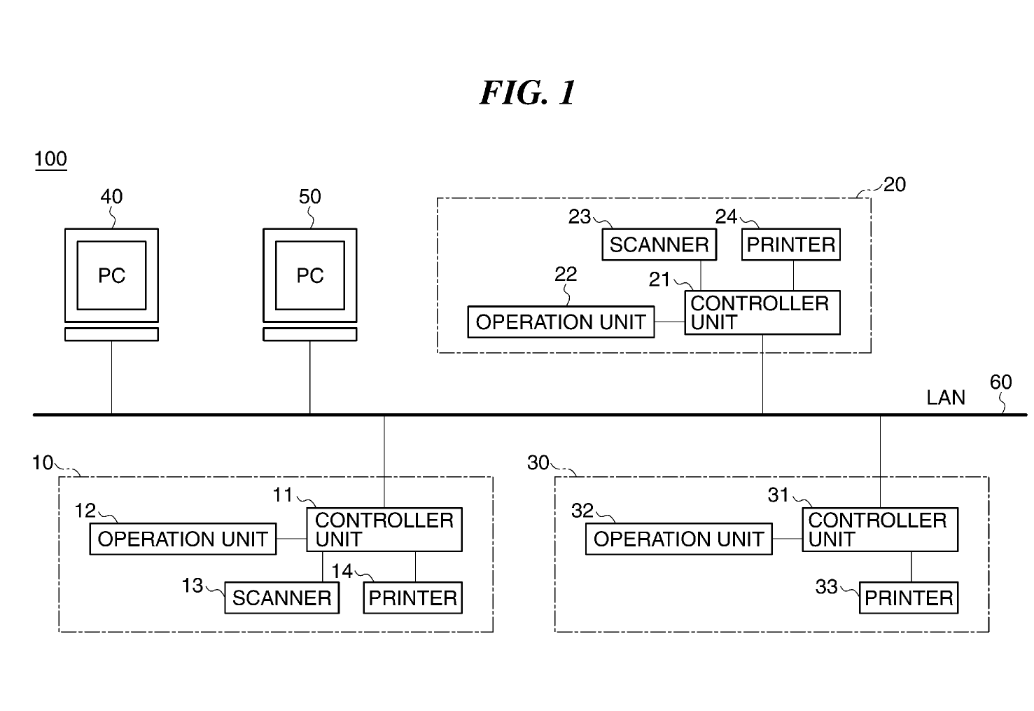

FIG. 1 is a diagram schematically showing an image forming system 100 including the image forming apparatus according to the embodiment of the present invention.

Referring to FIG. 1, PCs 40 and 50, which are host computers, and image forming apparatuses 10, 20, and 30 are connected to a LAN 60. According to the present invention, the number of terminals connected to the LAN 60 is not limited to this. Also, although in the present embodiment, a LAN is used as a connection method, the present invention is not limited to this, but an arbitrary network such as a WAN (public line) may also be used.

The PCs 40 and 50 have functions of personal computers. The PCs 40 and 50 are capable of sending and receiving files and electronic mails using FTP (file transfer protocol) and SMB (server message block) protocol via the LAN 60 and a WAN.

The PCs 40 and 50 are also capable of issuing printing instructions to the image forming apparatuses 10, 20, and 30 via printer drivers. The PCs 40 and 50 are also capable of making inquiries about statuses of the respective image forming apparatuses 10, 20, and 30 on a regular basis. In response to requests from the PCs 40 and 50, the image forming apparatuses 10, 20, and 30 can send information such as whether or not they are ready to perform printing.

The image forming apparatuses 10 and 20 have the same arrangement. The image forming apparatus 30 has only a print function and does not have a scanner which the image forming apparatuses 10 and 20 have.

The image forming apparatus is comprised of a scanner 13 which is an image input device, a printer 14 which is an image output device 14, a controller (controller unit) 11 which is responsible for controlling the overall operation of the image forming apparatus 10, and an operation unit 12 which is a user interface (UI).

Likewise, the image forming apparatus 20 is comprised of a scanner 23, a printer 24, a controller 21, and an operation unit 22. The image forming apparatus 30 is comprised of a printer 33, a controller 31, and an operation unit 32.

In the following description, the image forming apparatus 10 among the image forming apparatuses 10, 20, and 30 is taken as an example for ease of explanation if not otherwise specified. Thus, the electronic apparatus corresponds to the image forming apparatus 10, and external apparatuses correspond to the image forming apparatuses 20 and 30. The image forming apparatus 10 is capable of communicating with the image forming apparatuses 20 and 30, and a maximum amount of power that can be used by all of the image forming apparatuses 20 and 30 and the image forming apparatus 10 is determined in advance.

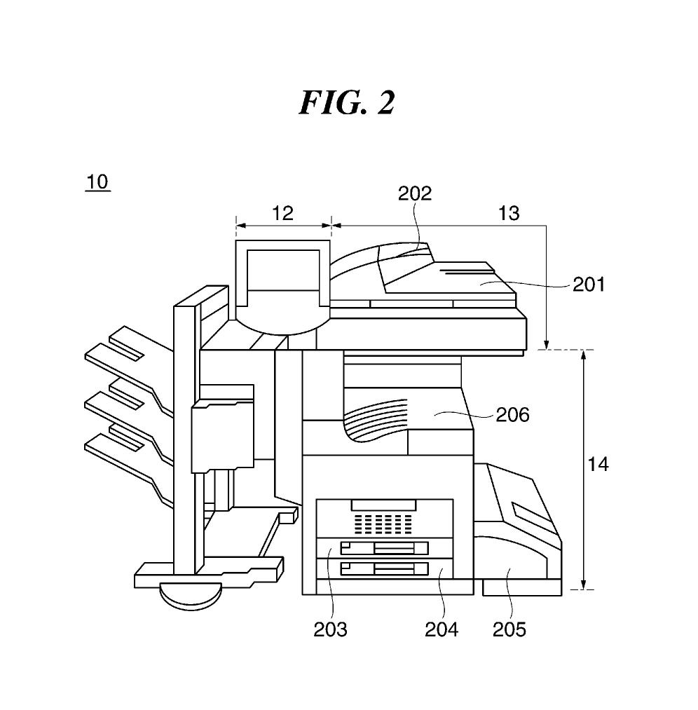

FIG. 2 is a view showing an appearance of the image forming apparatus 10 appearing in FIG. 1.

Referring to FIG. 2, the scanner 13 has a plurality of CCDs, and when the CCDs have different sensitivities, it will be recognized that pixels on an original have different densities even when the pixels actually have the same density. For this reason, at first, the scanner 13 scans a white board, which is uniformly white, by exposing the same to light, and the amount of reflected light obtained by scanning through light exposure is converted into an electric signal, which in turn is output to the controller 11.

Then, the scanner 13 scans an image on an original by exposing the same to light and inputs reflected light, which is obtained by scanning through exposure to light, to the CCDs, thus converting information of the image into an electric signal. The scanner 13 further converts the electric signal into a brightness signal comprised of R, G, and B colors, and outputs the brightness signal as image data to the controller 11.

It should be noted that originals are placed on a tray 202 of an original feeder 201. When a user issues a reading starting instruction from the operation unit 12, the controller 11 instructs the scanner 13 to read the originals.

Upon receiving the instruction to read the originals, the scanner 13 feeds the originals one by one from the tray 202 of the original feeder 201 to read the originals. It should be noted that the original reading method should not always be the automatic feed method using the original feeder 201 but may also be a method in which originals are placed on a glass surface, not shown, and scanned by moving an exposure unit.

The printer 14 forms image data received from the controller 11 on a sheet. It should be noted that although in the present embodiment, an image forming method is an electrophotpgrahic method using a photosensitive drum and a photosensitive belt, the present invention is not limited to this. For example, the present invention may be applied even to an inkjet method in which image data is printed on a sheet by jetting ink from a minute nozzle array.

The printer 14 is equipped with a plurality of sheet cassettes 203, 204, and 205 by which different sheet sizes or different sheet orientations can be selected. Printed sheets are discharged onto a discharged sheet tray 206.

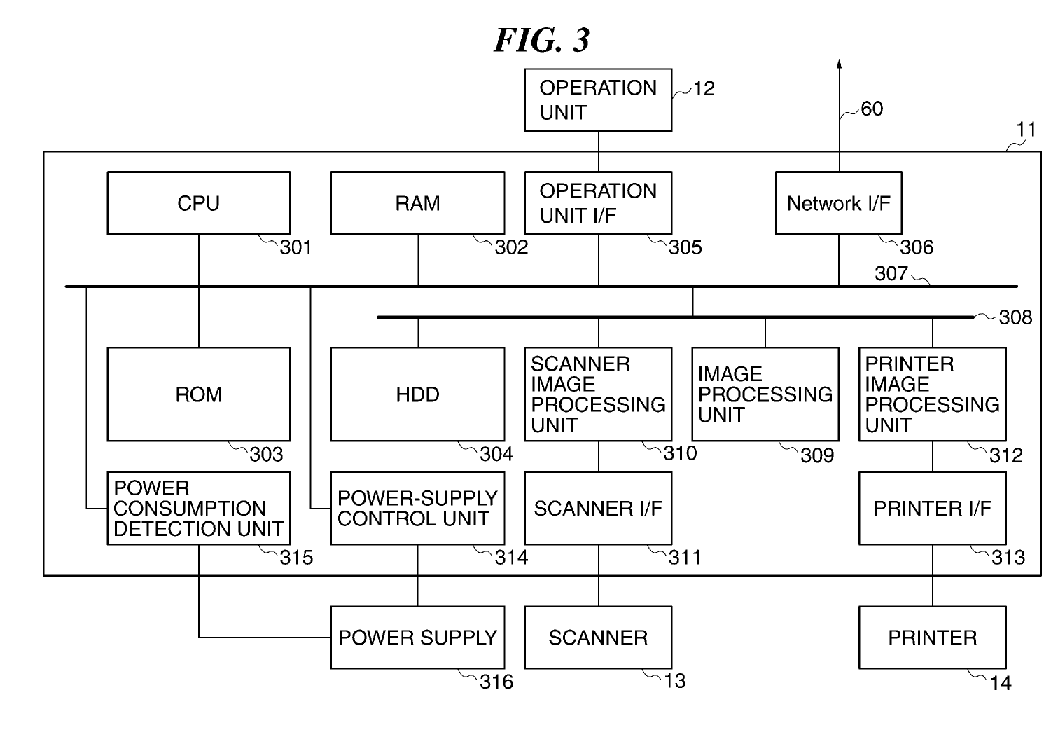

FIG. 3 is a diagram schematically showing an arrangement of the controller 11 of the image forming apparatus 10 appearing in FIG. 1.

Referring to FIG. 3, the controller 11 is electrically connected to the scanner 13 and the printer 14, and further connected to such as the PCs 40 and 50 external devices via the LAN 60 or the like. As a result, image data and device information can input to and output from the controller 11.

Based on control programs or the like stored in ROM 303, a CPU 301 exercises overall control over access to various devices being connected and also exercises overall control over various processes carried out inside the controller 11. Processes in flowcharts, to be described later, are carried out by the CPU 301 expanding programs from the ROM 303 into RAM 302.

The RAM 302 (storage unit) is system work memory for operation of the CPU 301 and also memory for temporarily storing image data. The RAM 302 is comprised of SRAM which holds stored data even after power-off, and DRAM which erases stored data after power-off.

A boot program for the image forming apparatus 10 and other data are stored in the ROM 303. An HDD 304 stores system software and image data.

An operation unit interface 305 connects a system bus 307 and the operation unit 12 together. The operation unit interface 305 receives image data, which is to be displayed on the operation unit 12, from the system bus 307 and outputs the image data to the operation unit 12, and also outputs information, which is input from the operation unit 12, to the system bus 307.

A network interface 306, which is connected to the LAN 60 and the system bus 307, inputs and outputs information. An image bus 308, which is a transmission path for sending and receiving image data, is comprised of a PCI bus or a bus conforming to IEEE 1394.

An image processing unit 309 is capable of reading image data stored in the RAM 302 stored in the RAM 302 and carrying out image processing enlargement or reduction or the like such as JPEG or JBIG and color adjustment on the image data.

A scanner image processing unit 310 corrects, processes, and edits image data received from the scanner 13 via a scanner interface 311. It should be noted that a scanner image processing unit 310 determines whether or not received image data is of a color original or a monochrome original, a character original or a photographic original, and so on. The scanner image processing unit 310 attaches the determination result to the image data. Such attached information is referred to as attribute data.

A printer image processing unit 312 subjects image data to image processing while referring to attribute data attached to the image data. The image data subjected to image processing is output to the printer 14 via a printer interface 313.

A power-supply control unit 314 controls power supply to the controller 11, the scanner 13, and the printer 14 by controlling a power supply 316 in accordance with instructions from the CPU 301.

A power consumption detection unit 315 constantly detects power consumed by the power supply 316. In accordance with an instruction from the CPU 301, the power consumption detection unit 315 sends a power consumption value at that point to the CPU 301.

The power supply 316 supplies power to the controller 11, the scanner 13, and the printer 14. Power supply is controlled by the power-supply control unit 314 described above.

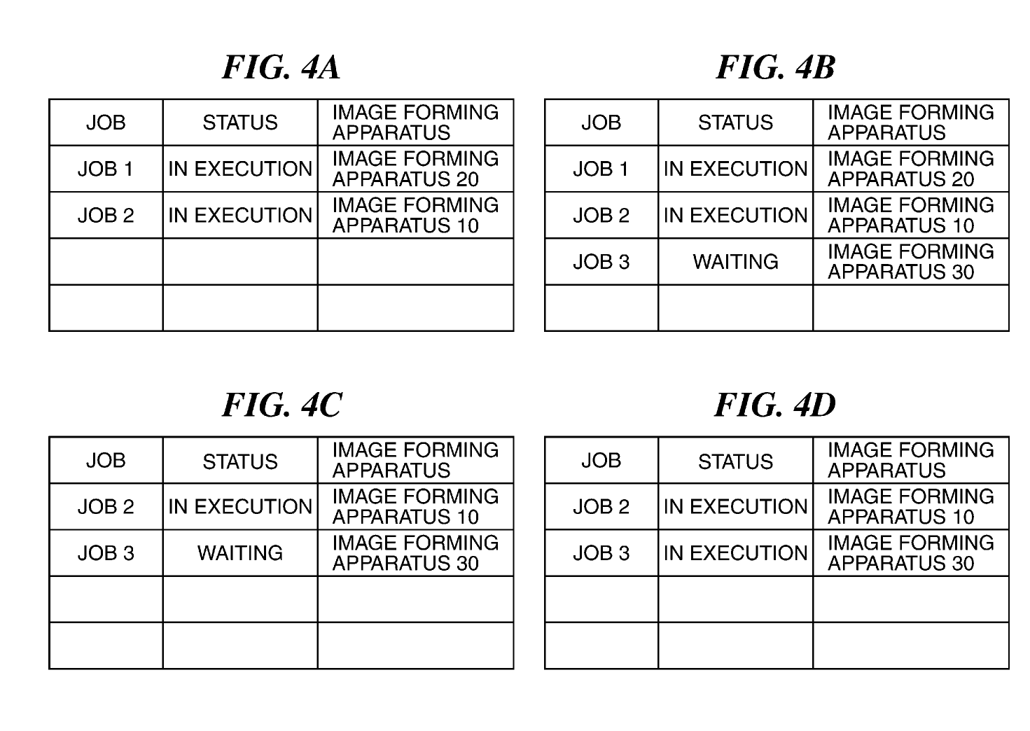

FIGS. 4A to 4D are diagrams showing exemplary job lists stored in the RAM 302 appearing in FIG. 3.

The job lists appearing in FIGS. 4A to 4D are jobs which the image forming apparatuses 10, 20, and 30 are going to execute, and indicate that the orders in which jobs are to be executed are the orders in which the image forming apparatuses 10, 20, and 30 have received the jobs.

Specifically, a job list is comprised of three items, “job”, “status”, and “image forming apparatus”. “Job” is information indicative of jobs which the image forming apparatuses 10, 20, and 30 are going to execute and information for identifying jobs. “Status (status information)” indicates statuses of respective jobs and also indicates whether each job is “in execution” or “waiting”. “Image forming apparatus” indicates image forming apparatuses which are currently executing jobs or going to execute jobs.

Jobs are executed in an order recorded in a job list. Here, an order means a descending order of jobs in a job list. Job lists stored in the respective image forming apparatuses 10, 20, and 30 have the same contents.

The job list appearing in FIG. 4A shows that the image forming apparatus 20 is now executing a job 1, and the image forming apparatus 10 is now executing a job 2.

The job list appearing in FIG. 4B shows that the image forming apparatus 20 is now executing a job 1, the image forming apparatus 10 is now executing a job 2, and a job 3 is waiting to be executed by the image forming apparatus 30.

The job list appearing in FIG. 4C shows that the image forming apparatus 10 is now executing a job 2, and a job 3 is waiting to be executed by the image forming apparatus 30.

The job list appearing in FIG. 4D shows that the image forming apparatus 10 is now executing a job 2, and the image forming apparatus 30 is now executing a job 3.

In the present embodiment, a job list is updated, for example, when the image forming apparatus 10 accepts execution of a process, and when notification that one of the image forming apparatuses 20 and 30 has accepted execution of a process is provided by that image forming apparatus.

Moreover, in the present embodiment, “status” of a job list is updated, for example, when the image forming apparatus 10 starts executing a job which has been planned to be executed, and when notification that one of the image forming apparatuses 20 and 30 starts executing a job which has been planned to be executed is provided by that image forming apparatus.

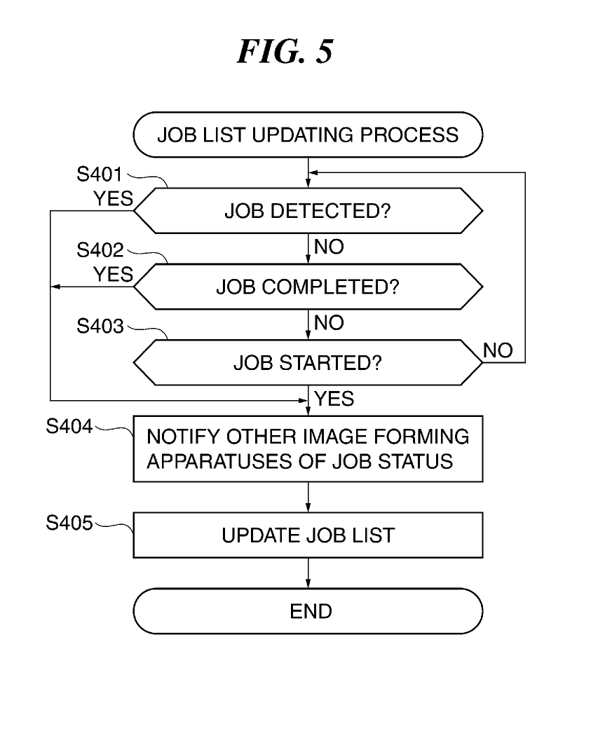

FIG. 5 is a flowchart showing the procedure of a job list updating process carried out by the CPU 301 appearing in FIG. 3.

The job list updating process in FIG. 5 is carried out by all the image forming apparatuses 10, 20, and 30. First, the CPU 301 determines whether or not it has detected a job (step S401). This determination is made based on whether or not a print job has been input by a user via the network interface 306, whether or not a copy job has been input by the user via the operation unit 12, or the like.

When, as a result of the determination in the step S401, the CPU 301 has detected a job (YES in the step S401), the process proceeds to step S404.

On the other hand, when, as a result of the determination in the step S401, the CPU 301 has not detected a job (NO in the step S401), the CPU 301 determines whether or not a job has been completed (step S402). This determination is made based on whether or not discharging of all sheets has been completed for a print job, whether or not reading of sheets required for a scan job has been done and an operation desired by the user has been carried out, or the like.

When, as a result of the determination in the step S402, a job has been completed (YES in the step S402), the process proceeds to the step S404.

On the other hand, when, as a result of the determination in the step S402, a job has not been completed (NO in the step S402), the CPU 301 determines whether or not a job has been started (step S403). This determination is made based on whether or not, after a job is detected in the step S401, the image forming apparatus is ready to execute a job, that is, electric current is passed through the scanner 13, the printer 14, and so on to bring the image forming apparatus into an operable state.

When, as a result of the determination in the step S403, a job has not been started (NO in the step S403), the process returns to the step S401.

When, as a result of the determination in the step S403, a job has been started (YES in the step S403), the CPU 301 notifies other image forming apparatuses of a job status (step S404). Specifically, for example, when the image forming apparatus 10 detects a job, determines that a job has been completed, or determines that a job has been started, the other image forming apparatuses 20 and 30 is notified to this effect. Information given to the image forming apparatuses 20 and 30 at this time is information including “job” and “status” which have been changed in a job list appearing in FIG. 4. “Image forming apparatus” can be identified from a sender of the information.

The CPU 301 then updates a job list for the image forming apparatus 10 (step S405) and bring the present process to an end. At this time, job lists for the other image forming apparatuses 20 and 30 to which the information was given are also updated.

Taking FIGS. 4A to 4D as examples, a description will be given of how a job list is updated. When the image forming apparatus 30 detects a job, the job list appearing in FIG. 4A is updated to the job list appearing in FIG. 4B. Thereafter, when a job is completed in the image forming apparatus 20, the job list appearing in FIG. 4B is updated to the job list appearing in FIG. 4C. Further, when a job is started in the image forming apparatus 30, the job list appearing in FIG. 4C is updated to the job list appearing in FIG. 4D.

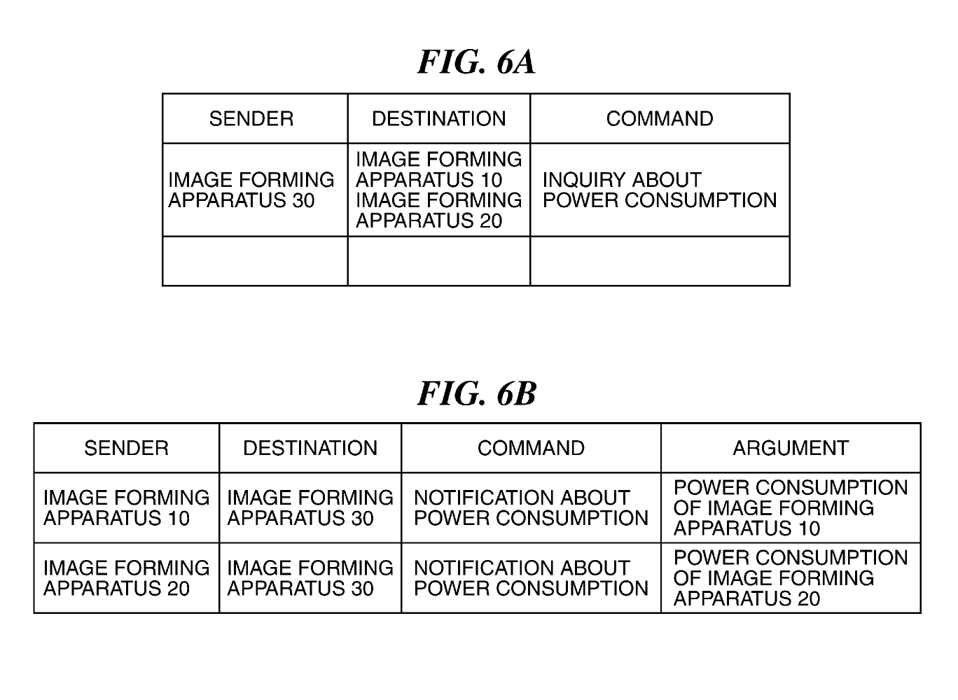

FIGS. 6A and 6B are diagrams showing message formats sent and received between image forming apparatuses.

FIG. 6A shows a message format for use in inquiring of other image forming apparatuses about power consumption, and shows, for example, information which the image forming apparatus 30 sends as a command to the image forming apparatuses 10 and 20 when inquiring about power consumption. This command in FIG. 6A is sent to all the other image forming apparatuses.

FIG. 6B shows a message format for use in responding to an inquiry about power consumption and shows information which the image forming apparatuses 10 and 20 send as a command to the image forming apparatus 30 in response to the command in FIG. 6A when they notify the image forming apparatus 30 of power consumption. This information includes power consumption in an augment, and hence the image forming apparatus 30 can obtain power consumption of the other image forming apparatuses 10 and 20. These commands are sent by the power consumption detection unit 315.

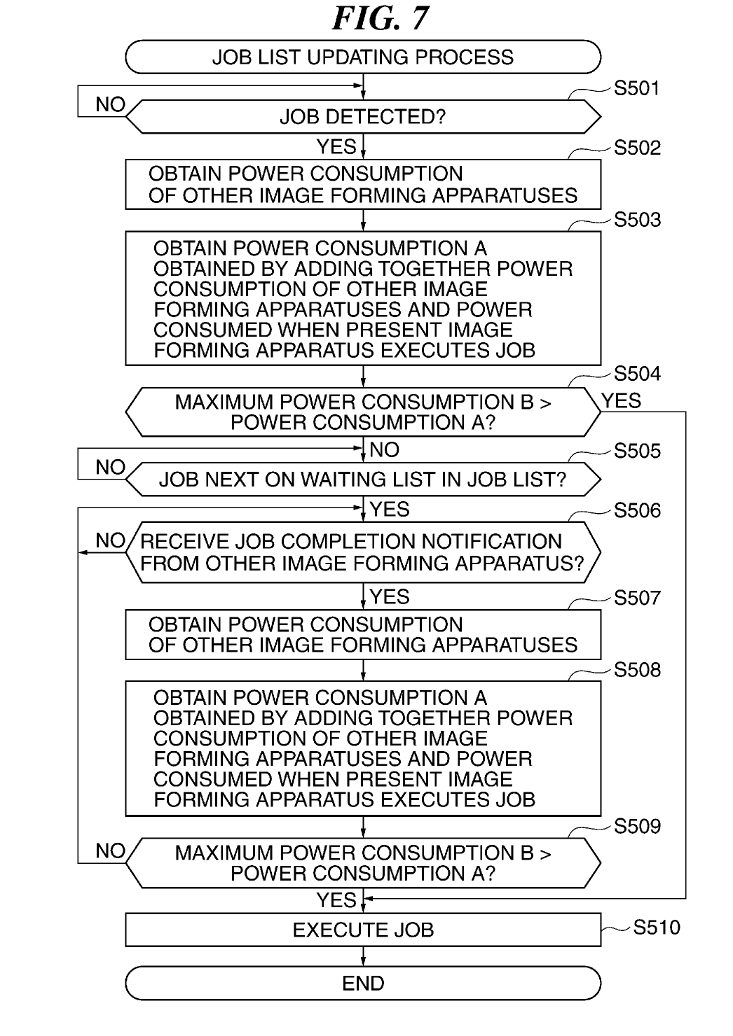

FIG. 7 is a flowchart showing the procedure of a job power control process carried out by the CPU 301 appearing in FIG. 3. It should be noted that in FIG. 7, an image forming apparatus that carries out this job power control process is expressed sometimes as the present image forming apparatus so as to be distinguished from other image forming apparatuses.

Referring to FIG. 7, upon detecting a job (YES in step S501), the CPU 301 of the present image forming apparatus sends the command appearing in FIG. 6A to the other image forming apparatuses. Here, the command appearing in FIG. 6B is sent from the other image forming apparatuses in response to the command appearing in FIG. 6A, and as a result, the CPU 301 obtains power consumption of the other image forming apparatuses (step S502).

The CPU 301 then obtains power consumption A which is a sum of the obtained total power consumption of the other image forming apparatuses and power consumed when the present image forming apparatus executes the job (step S503). The CPU 301 then determines whether or not maximum power consumption B is greater than the power consumption A (step S504). The maximum power consumption B is stored in advance in the ROM 303 or the HDD 304.

When, as a result of the determination in the step S504, the maximum power consumption B is greater than the power consumption A (YES in the step S504), the CPU 301 executes the job (step S510) and brings the present process to an end.

On the other hand, when, as a result of the determination in the step S504, the maximum power consumption B is not greater than the power consumption A (NO in the step S504), the CPU 301 refers to a job list and determines whether or not the job which the present image forming apparatus is going to execute is next on a waiting list (step S505: determination unit).

When, as a result of the determination in the step S505, the job which the present image forming apparatus is going to execute is not next on a waiting list (NO in the step S505), the CPU 301 stands by until the job is next on a waiting list.

On the other hand, when, as a result of the determination in the step S505, the job which the present image forming apparatus is going to execute is next in line (YES in the step S505), the CPU 301 determines whether or not it has received a job completion notification from the other image forming apparatuses (step S506: receiving unit).

When, as a result of the determination in the step S506, the CPU 301 has not received the job completion notification from the other image forming apparatuses (NO in the step S506), the CPU 301 stands by until it receives the job completion notification.

On the other hand, when, as a result of the determination in the step S506, the CPU 301 has received the job completion notification from the other image forming apparatuses (YES in the step S506), the CPU 301 obtains power consumption of the other image forming apparatuses using the commands appearing in FIGS. 6A and 6B (step S507: obtaining unit).

The CPU 301 then obtains power consumption A which is a sum of the obtained total power consumption of the other image forming apparatuses and power consumed when the present image forming apparatus executes the job again (step S508). The CPU 301 then determines whether or not the maximum power consumption B is greater than the power consumption A (step S509).

When, as a result of the determination in the step S509, the maximum power consumption B is not greater than the power consumption A (NO in the step S509), the process returns to the step S506.

On the other hand, when, as a result of the determination in the step S509, the maximum power consumption B is greater than the power consumption A (YES in the step S509), the CPU 301 executes the job (step S510: execution unit) and brings the present process to an end.

According to the process in FIG. 7, jobs can be executed in the order in which instructions to execute the jobs were received while maximum power consumption is never exceeded.

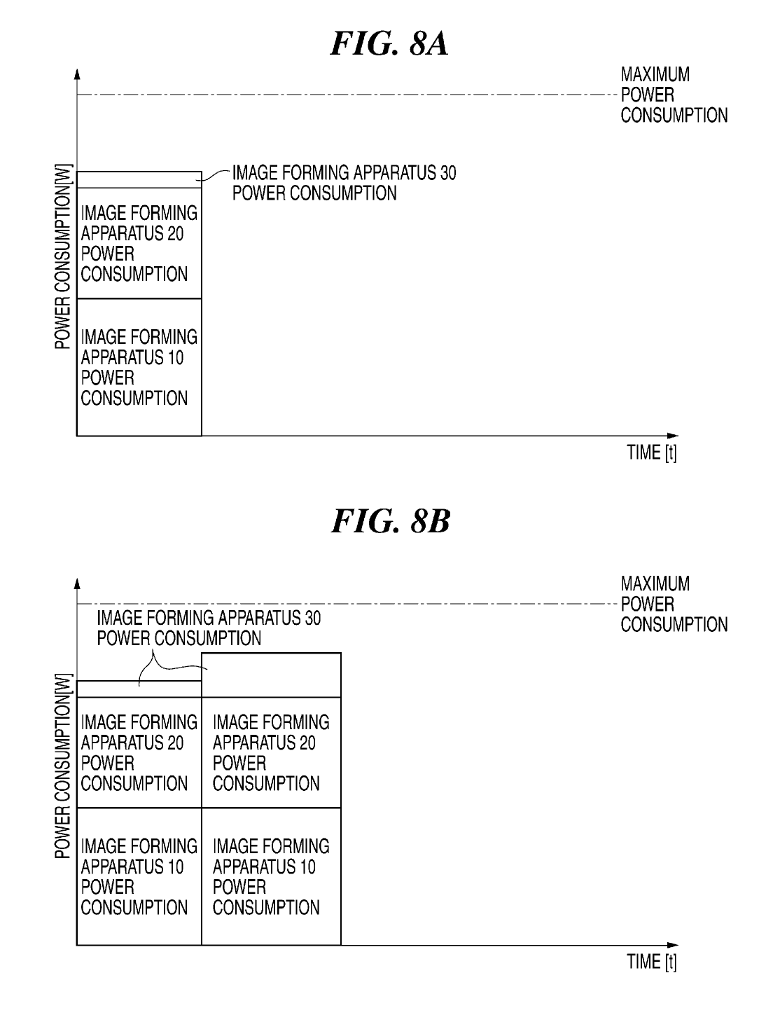

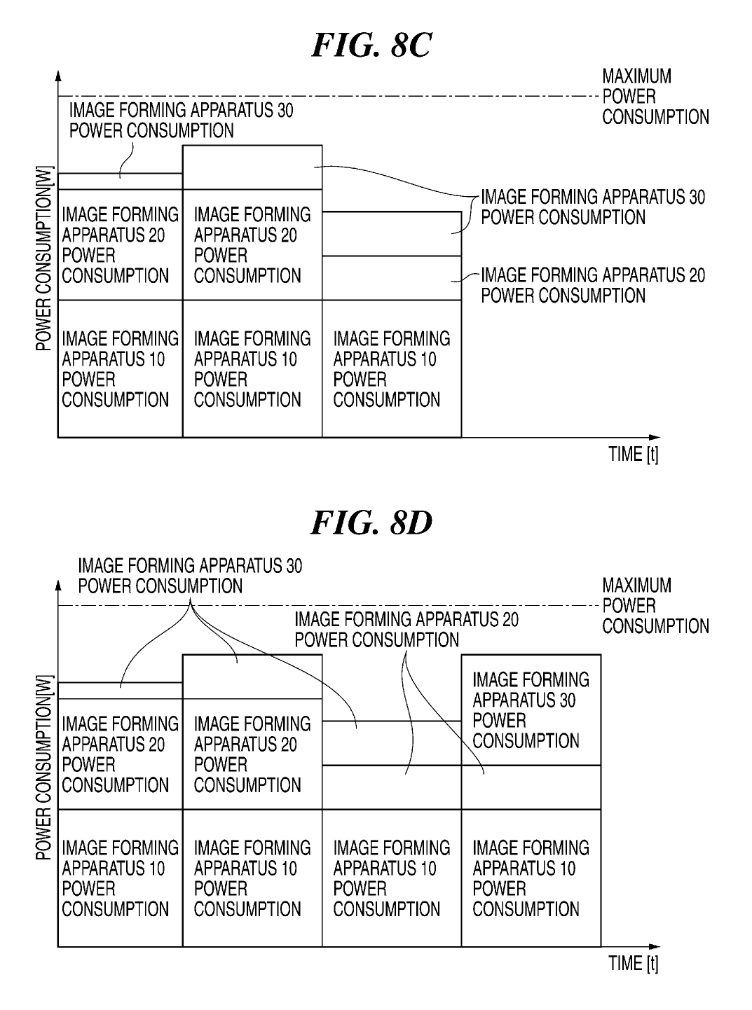

FIGS. 8A to 8D are diagrams useful in explaining concrete examples of changes in power consumption when the job power control process in FIG. 7 is carried out.

FIGS. 8A to 8D are diagrams showing power consumption. In graphs shown in the respective figures, the vertical axis designates power consumption, and the horizontal axis designates time. In FIGS. 8A to 8D, it is assumed that the present image forming apparatus is the image forming apparatus 30.

First, when the image forming apparatus 30 has detected no job, total power consumption of the image forming apparatuses 10, 20, and 30 is in a state shown in the graph of FIG. 8A.

When the image forming apparatus 30 has detects a job, the image forming apparatus 30 obtains power consumption from the image forming apparatuses 10 and 20. As a result, total power consumption of the image forming apparatuses 10, 20, and 30 is brought into a state shown in the graph of FIG. 8B.

Then, for example, when the image forming apparatus 20 completes a job, the image forming apparatus 20 turns off power supply to the printer 24 and the scanner 23. As a result, total power consumption of the image forming apparatuses 10, 20, and 30 is brought into a state shown in the graph of FIG. 8C.

The image forming apparatus 30 then executes a job. As a result, total power consumption of the image forming apparatuses 10, 20, and 30 is brought into a state shown in the graph of FIG. 8D.

Although in the present embodiment described above, an image forming apparatus is taken as an example of the electronic apparatus, it goes without saying that the present invention may be applied to any electronic apparatus as long as it has an arrangement of an ordinary PC and is capable of communicating with other apparatuses as shown in the present embodiment.

Further, the present invention may be applied to either a system comprised of a plurality of devices (for example, a computer, an interface device, a reader, a printer, and so on) or an apparatus comprised of one device (a multifunctional peripheral, a printer, or a facsimile machine).

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-266223 filed Dec. 5, 2012, which is hereby incorporated by reference herein in its entirety.

What is claimed is:

1. An electronic apparatus which is capable of communicating with at least one external apparatus, and for which maximum power consumption by all of the at least one external apparatus and the electronic apparatus is determined in advance, comprising:
a storage unit configured to store a list indicating jobs planned to be executed by respective ones of the at least one external apparatus and the electronic apparatus, and indicating that an order in which the jobs planned to be executed are executed is an order in which the at least one external apparatus and the electronic apparatus have received the jobs;
an order determination unit configured to, based on the list stored in said storage unit, determine whether the job planned to be executed by the electronic apparatus is next on a waiting list;
a receiving unit configured to receive, from any one of the at least one external apparatus, a completion notification indicating that the job executed by the external apparatus has been completed;
an obtaining unit configured to obtain power consumption from all of the at least one external apparatus when said order determination unit determines that the job planned to be executed by the electronic apparatus is next on a waiting list, and said receiving unit receives the completion notification; and
an execution unit configured to execute the job planned to be executed when a sum of total power consumption of the at least one external apparatus obtained by said obtaining unit and power consumed when the electronic apparatus executes the job planned to be executed is smaller than the maximum power consumption.

2. The electronic apparatus according to claim 1, wherein the list is updated when the electronic apparatus receives the job, and upon receiving notification that any one of the at least one external apparatus has received the job from this external apparatus.

3. The electronic apparatus according to claim 2, wherein the list includes status information indicating statuses of the jobs planned to be executed and indicating that the jobs are being currently executed, and
the status information in the list is updated when the electronic apparatus starts executing the job planned to be executed, and upon receiving notification that any one of the at least one external apparatus starts executing another job planned to be executed from this external apparatus.

4. The electronic apparatus according to claim 2, wherein when the electronic apparatus receives the job, the at least one external apparatus is notified that the job has been received, and when the electronic apparatus starts executing the job planned to be executed, the at least one external apparatus is notified that execution of the job planned to be executed has been started.

5. A control method for an electronic apparatus which is capable of communicating with at least one external apparatus, and for which maximum power consumable by all of the at least one external apparatus and the electronic apparatus is determined in advance, and has a storage unit that stores a list indicating jobs planned to be executed by respective ones of the at least one external apparatus and the electronic apparatus, and indicating that an order in which the jobs planned to be executed are executed is an order in which the at least one external apparatus and the electronic apparatus have received the jobs, comprising:
an order determination step of, based on the list stored in the storage unit, determining whether the job planned to be executed by the electronic apparatus is next on a waiting list;
a receiving step of receiving, from any one of the at least one external apparatus, a completion notification indicating that the job executed by the external apparatus has been completed;
an obtaining step of obtaining power consumption from all of the at least one external apparatus when it is determined in said order determination step that the job planned to be executed by the electronic apparatus is next on a waiting list, and the completion notification is received in said receiving step; and
an execution step of executing the job planned to be executed when a sum of total power consumption of the at least one external apparatus obtained in said obtaining step and power consumed when the electronic apparatus executes the job planned to be executed is smaller than the maximum power consumption.

6. The control method according to claim 5, wherein the list is updated when the electronic apparatus receives the job, and upon receiving notification that any one of the at least one external apparatus has received the job from this external apparatus.

7. The control method according to claim 6, wherein the list includes status information indicating statuses of the jobs planned to be executed and indicating that the jobs are being currently executed, and
the status information in the list is updated when the electronic apparatus starts executing the job planned to be executed, and upon receiving notification that any one of the at least one external apparatus starts executing another job planned to be executed from this external apparatus.

8. The control method according to claim 7, wherein when the electronic apparatus receives the job, the at least one external apparatus is notified that the job has been received, and when the electronic apparatus starts executing the job planned to be executed, the at least one external apparatus is notified that execution of the job planned to be executed has been started.

9. A non-transitory computer-readable storage medium storing a program for causing a computer to execute a control method for an electronic apparatus which is capable of communicating with at least one external apparatus, and for which maximum power consumable by all of the at least one external apparatus and the electronic apparatus is determined in advance, and has a storage unit that stores a list indicating jobs planned to be executed by respective ones of the at least one external apparatus and the electronic apparatus, and indicating that an order in which the jobs planned to be executed are executed is an order in which the at least one external apparatus and the electronic apparatus have received the jobs, the control method comprising:
an order determination step of, based on the list stored in the storage unit, determining whether the job planned to be executed by the electronic apparatus is next on a waiting list;
a receiving step of receiving, from any one of the at least one external apparatus, a completion notification indicating that the job executed by the external apparatus has been completed;
an obtaining step of obtaining power consumption from all of the at least one external apparatus when it is determined in the order determination step that the job planned to be executed by the electronic apparatus is next on a waiting list, and the completion notification is received in the receiving step; and
an execution step of executing the job planned to be executed when a sum of total power consumption of the at least one external apparatus obtained in the obtaining step and power consumed when the electronic apparatus executes the job planned to be executed is smaller than the maximum power consumption.

10. The non-transitory computer-readable storage medium according to claim 9, wherein the list is updated when the electronic apparatus receives the job, and upon receiving notification that any one of the at least one external apparatus has received the job from this external apparatus.

11. The non-transitory computer-readable storage medium according to claim 10, wherein the list includes status information indicating statuses of the jobs planned to be executed and indicating that the jobs are being currently executed, and
the status information in the list is updated when the electronic apparatus starts executing the job planned to be executed, and upon receiving notification that any one of the at least one external apparatus starts executing another job planned to be executed from this external apparatus.

12. The non-transitory computer-readable storage medium according to claim 11, wherein when the electronic apparatus receives the job, the at least one external apparatus is notified that the job has been received, and when the electronic apparatus starts executing the job planned to be executed, the at least one external apparatus is notified that execution of the job planned to be executed has been started.
